(19) United States
(12) Patent Application Publication
(10) Pub. No.: US 2025/0211463 A1
(43) Pub. Date: Jun. 26, 2025

(54) MICROCONTROLLER UNIT AND ELECTRONIC DEVICE

(71) Applicant: Nuvoton Technology Corporation, Hsinchu Science Park (TW)

(72) Inventors: Ta-Chin CHIU, Hsinchu Science Park (TW); Chieh-Sheng TU, Hsinchu Science Park (TW)

(21) Appl. No.: 18/806,996

(22) Filed: Aug. 16, 2024

(30) Foreign Application Priority Data
Dec. 22, 2023 (TW) 112150268

(51) Int. Cl. H04L 12/40

(52) U.S. Cl. CPC H04L 12/40013; H04L 2012/40215

(57) ABSTRACT

A microcontroller unit (MCU) with a controller area network (CAN) function. The MCU provides a CAN controller for the CAN function, to generate a transmission signal (CANTX) in digital form. The MCU also has a digital signal remapping circuit inside, which remaps the CANTX signal into a first chip output and a second chip output. The MCU has a first pin that outputs the first chip output to drive a differential positive signal line (CANH) of the CAN function. The MCU has a second pin that outputs the second output to drive a differential negative signal line (CANL) of the CAN function.

### CROSS REFERENCE TO RELATED APPLICATIONS

This application claims priority of Taiwan Patent Application No. 112150268, filed on Dec. 22, 2023, the entirety of which is incorporated by reference herein.

### BACKGROUND OF THE INVENTION

### Field of the Invention

The present invention relates to transmission line control of a controller area network (CAN).

### Description of the Related Art

A Controller Area Network (CAN) is a feature-rich bus standard for microcontroller units (MCU) to communicate with instruments without a host device.

Under the traditional design, an MCU needs to be connected to a CAN transceiver, for conversion of a digital form of a transmission signal CANTX, so that it can drive a differential positive signal line CANH and a differential negative signal line CANL.

However, a CAN transceiver is quite expensive, and this will increase the overall cost of the electronic device.

### BRIEF SUMMARY OF THE INVENTION

This disclosure replaces a CAN transceiver in a low-cost way.

In accordance with an exemplary embodiment of the disclosure, a microcontroller unit (MCU) includes a communication controller (as known as a CAN controller), a digital signal remapping circuit, a first pin, and a second pin. The CAN controller generates a transmission signal for the CAN in digital form. The digital signal remapping circuit remaps the transmission signal into a first chip output signal and a second chip output signal. The MCU outputs the first chip output signal to drive a differential positive signal line CANH of the CAN. The MCU outputs the second chip output signal to drive a differential negative signal line CANL of the CAN.

In an exemplary embodiment, the MCU also has a third pin, a fourth pin, and a comparator. The MCU is coupled to the differential positive signal line CANH of the CAN via the third pin, and is coupled to the differential negative signal line CANL of the CAN via the fourth pin. The comparator receives signals from the third pin and the fourth pin for comparison, to generate a received signal CANRX in digital form, which is coupled to the CAN controller.

A traditional MCU outputs the transmission signal (CANTX) to be processed by an expensive CAN transceiver to realize the driving of the CAN transmission line. In the disclosure, preliminary conversion is performed on the transmission signal CANTX inside the MCU, to replace some of the functions of the CAN transceiver. In addition, the traditional MCU uses the CAN transceiver to convert the received signal (CANRX) and then inputs it into the MCU. In the disclosure, the MCU itself converts the received signal (CANRX). In this disclosure, an expensive CAN transceiver is not required.

This case further proposes an electronic device using the aforementioned MCU.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram illustrating an electronic device 100 in accordance with an exemplary embodiment of the disclosure, which includes a microcontroller unit (MCU for short) 102; and

FIGS. 2, 3, and 4 illustrate electronic devices 200, 300, and 400 in accordance with several exemplary embodiments of the disclosure.

### DETAILED DESCRIPTION OF THE INVENTION

The following description enumerates various embodiments of the disclosure. The following description introduces the basic concepts of the disclosure and is not intended to limit the scope of the disclosure. The actual scope of the disclosure should be determined by reference to the appended claims. Various functional blocks are not limited to being implemented separately, but may also be combined together to share certain functions.

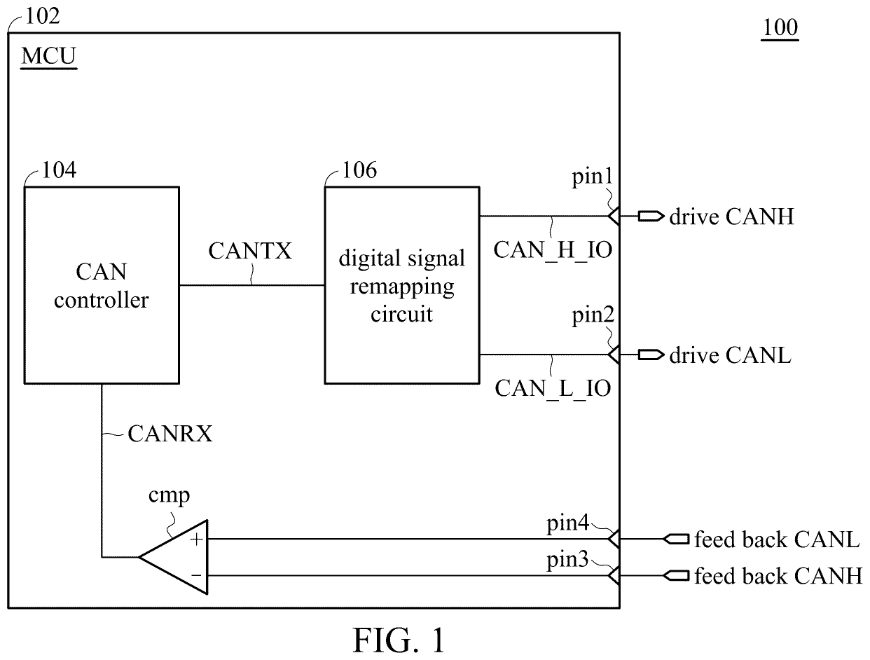

FIG. 1 is a block diagram illustrating an electronic device 100 in accordance with an exemplary embodiment of the disclosure, which includes a microcontroller unit (MCU for short) 102. The MCU 102 includes a controller area network controller (CAN controller) 104 that complies with a controller area network (CAN) specification. The CAN controller 104 generates a transmission signal CANTX in digital form. The MCU 102 further includes a digital signal remapping circuit 106 that remaps the transmission signal CANTX into a first chip output signal CAN_H_IO and a second chip output signal CAN_L_IO. The MCU 102 outputs the first chip output signal CAN_H_IO via a first pin pin1 to drive a differential positive signal line CANH of the CAN, and outputs the second chip output signal CAN_L_IO via a second pin pin2 to drive a differential negative signal line CANL of the CAN.

A traditional MCU directly outputs the transmission signal CANTX to an expensive CAN transceiver for further processing. In contrast, in this disclosure, the digital signal remapping circuit 106 inside the MCU 102 converts the transmission signal CANTX into two signals (CAN_H_IO and CAN_L_IO), so that the differential positive signal line CANH and the differential negative signal line CANL of the CAN are driven separately. Thus, the driving timing can be easily adjusted, which is beneficial to realize high-speed transmission.

As for the receiving function of the traditional CAN transceiver, a proper solution is also proposed in this disclosure.

As shown in FIG. 1, the MCU 102 also has a third pin pin3, a fourth pin pin4, and a comparator cmp. The MCU 102 uses its third pin pin3 to couple to the differential positive signal line CANH of the CAN, and uses its fourth pin pin4 to couple to the differential negative signal line CANL of the CAN. The comparator cmp has a negative input terminal ‘−’ coupled to the third pin pin3 and a positive input terminal ‘+’ coupled to the fourth pin pin4 to compare the received signals to generate a received signal CANRX in a digital form to input to the CAN controller 104. In this way, the MCU 102 itself converts the received signal CANRX and feeds it back to the CAN controller 104. A receiving function of a traditional CAN transceiver is replaced.

Table 1 shows the transmission rules of a transmission line of the CAN.

TABLE 1

| | CANTX = ‘1’ | | | CANTX = ‘0’ | | |
|---|---|---|---|---|---|---|
| | | | maxi- | | | maxi- |
| | mini- | typical | mum | mini- | typical | mum |
| | mum | value | value | mum | value | value |
| CANH | 2.00 | 2.50 | 3.00 | 2.75 | 3.50 | 4.50 |
| CANL | 2.00 | 2.50 | 3.00 | 0.50 | 1.50 | 2.25 |
| CANH- | −0.5 | 0 | +0.05 | +1.5 | +2.0 | +3.0 |
| CANL | | | | | | |

The digital signal remapping circuit 106 in this disclosure remaps the transmission signal CANTX to the first chip output signal CAN_H_IO and the second chip output signal CAN_L_IO to be coupled to external circuits to drive the differential positive signal line CANH and the differential negative signal line CANL according to the rules of Table 1.

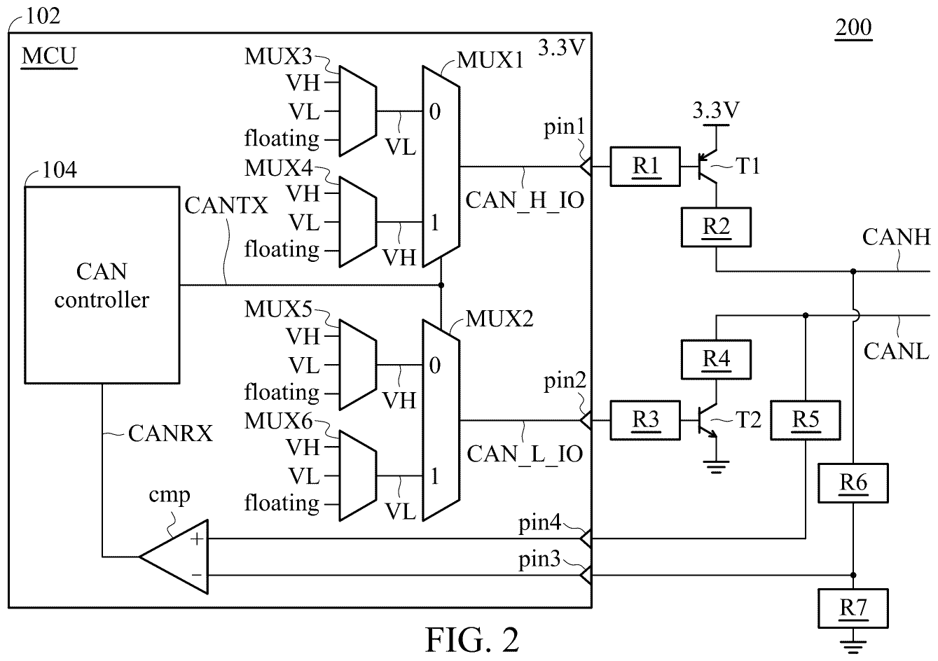

FIG. 2 illustrates an electronic device 200 in accordance with an exemplary embodiment of the disclosure.

The multiplexers MUX1˜MUX6 constitute the digital signal remapping circuit 106 specially provided inside the MCU 102 in the disclosure. In particular, the multiplexers within the chip shown in this example are digital multiplexers. The first multiplexer MUX1 outputs the first chip output signal CAN_H_IO according to the control of the transmission signal CANTX. The second multiplexer MUX2 outputs the second chip output signal CAN_L_IO according to the control of the transmission signal CANTX. The third to sixth multiplexers MUX3 to MUX6 each have a first input terminal that receives a high potential VH, a second input terminal that receives a low potential VL, and a third input terminal that is floating. The output terminal of the third multiplexer MUX3 is coupled to the first input terminal ‘0’ of the first multiplexer MUX1. The output terminal of the fourth multiplexer MUX4 is coupled to the second input terminal ‘l’ of the first multiplexer MUX1. The output terminal of the fifth multiplexer MUX5 is coupled to the first input terminal ‘O’ of the second multiplexer MUX2. The output terminal of the sixth multiplexer MUX6 is coupled to the second input terminal ‘l’ of the second multiplexer MUX2.

Under such a design, the digital signal remapping circuit 106 flexibly provides the first chip output signal CAN_H_IO and the second chip output signal CAN_L_IO to correspond to the external circuits of the MCU 102, and so as to follow the rules of Table 1 to drive the differential positive signal line CANH and the differential negative signal line CANL.

The control of the third multiplexer MUX3 and the fourth multiplexer MUX4 depends on how the first chip output signal CAN_H_IO output from the first pin1 drives the differential positive signal line CANH. The control of the fifth multiplexer MUX5 and the sixth multiplexer MUX6 depends on how the second chip output signal CAN_L_IO output from the second pin 2 drives the differential negative signal line CANL.

In the exemplary embodiment of FIG. 2, the third multiplexer MUX3 selects the low potential VL to input to the first input terminal ‘0’ of the first multiplexer MUX1, and the fourth multiplexer MUX4 selects the high potential VH to be input to the second input terminal ‘l’ of the first multiplexer MUX1. The fifth multiplexer MUX5 selects the high voltage VH to be input to the first input terminal ‘0’ of the second multiplexer MUX2. The sixth multiplexer MUX6 selects the low potential VL to be input to the second input terminal ‘l’ of the second multiplexer MUX2.

Corresponding to the remapping design (MUX1˜MUX6) in FIG. 2, the electronic device 200 is coupled to a first driving circuit (including a first transistor T1, a first resistor R1 and a second resistor R2) via the first pin pin1 of the MCU 102 to drive the differential positive signal line CANH, and is coupled to a second driving circuit (including a second transistor T2, a third resistor R3, and a fourth resistor R4) via the second pin pin2 of the MCU 102 to drive the differential negative signal line CANL. The first transistor T1 has an emitter coupled to a voltage source (3.3V as shown in the figure, or other), a base coupled to the first pin pin1 through the first resistor R1, and a collector coupled to the differential positive signal line CANH through the second resistor R2. The second transistor T2 has an emitter grounded, a base coupled to the second pin pin2 through the third resistor R3, and a collector coupled to the differential negative signal line CANL through the fourth resistor R4. In this design, the differential positive signal line CANH and the differential negative signal line CANL indeed comply with the specifications in Table 1, and operate in response to the transmission signal CANTX.

In particular, the first driving circuit (T1, R1, R2) and the second driving circuit (T2, R3, R4) are symmetrically provided to drive the differential positive signal line CANH and the differential negative signal line CANL with approximately no time difference. The electronic device 200 may be a high-speed device. The resistors R1˜R4 may be slightly tuned to comply with the CAN specifications.

In the figure, the differential negative signal line CANL is coupled to the fourth pin pin4 through a fifth resistor R5, and the differential positive signal line CANH is coupled to the third pin pin3 through a voltage divider (referring to the sixth resistor R6 and the seventh resistor R7 connected in series). The MCU 102 accurately performs the comparison to generate the received signal CANRX internally, and feeds it back to the CAN controller 104. The resistors R5˜R7 may be slightly tuned to comply with the CAN specifications.

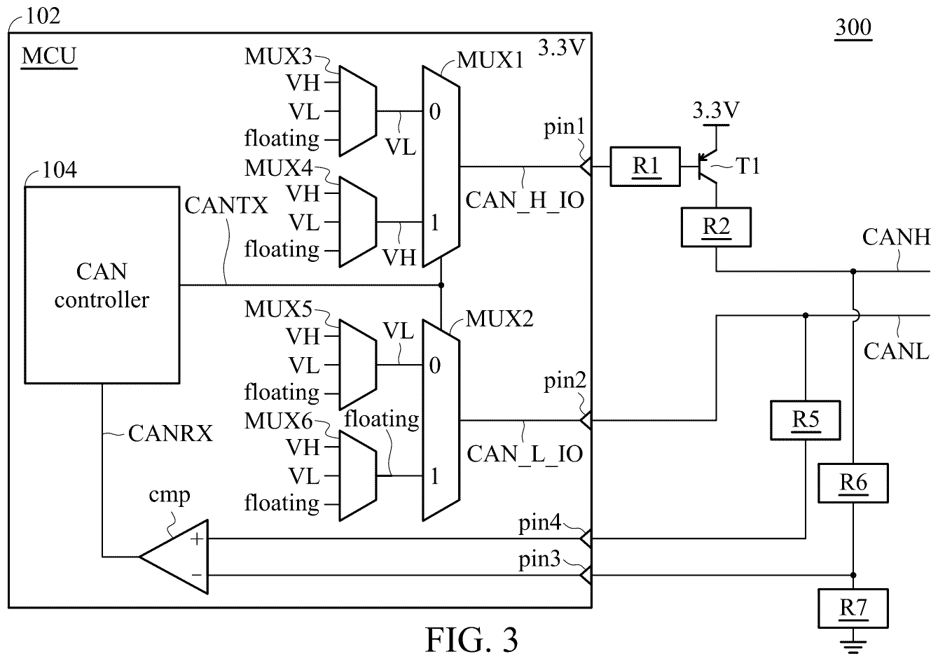

FIG. 3 illustrates an electronic device 300 in accordance with another exemplary embodiment of the present invention. In the embodiment of FIG. 3, the input design of the first multiplexer MUX1 is the same as that of FIG. 2. The fifth multiplexer MUX5 selects the low voltage VL to be input to the first input terminal ‘0’ of the second multiplexer MUX2, and the sixth multiplexer MUX6 selects its floating input to the second input terminal ‘l’ of the second multiplexer MUX2. As shown, the second pin pin2 is directly connected to the differential negative signal line CANL without passing through the second driving circuit (T2, R3, R4) in FIG. 2, which results the stronger driving force. Under such a design, the differential negative signal line CANL still follows the specifications in Table 1, and operate in response to the transmission signal CANTX.

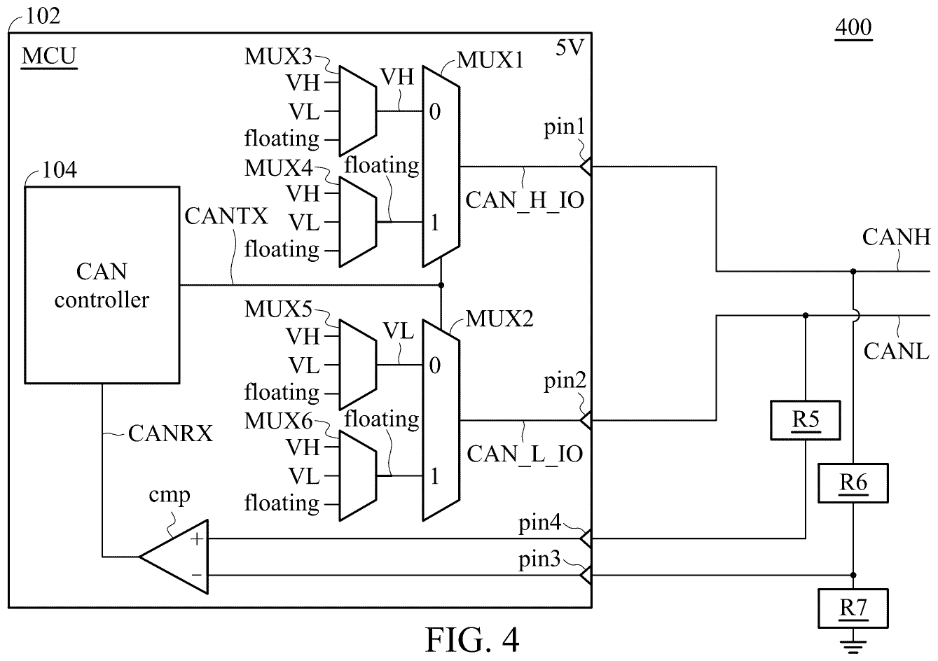

FIG. 4 illustrates another electronic device 400 in accordance with an exemplary embodiment of the present invention. In the exemplary embodiment of FIG. 4, the third multiplexer MUX3 selects the high potential VH to be input to the first input terminal ‘0’ of the first multiplexer MUX1, and the fourth multiplexer MUX4 selects its floating input to the second input terminal ‘l’ of the first multiplexer MUX1. The input design of the second multiplexer MUX2 is the same as that of FIG. 3. The first pin pin1 is directly connected to the differential positive signal line CANH without passing through the first drive circuit (T1, R1, R2) shown in FIGS. 2 and 3, which results in the stronger driving force. The electronic device 400 in FIG. 4 drives the differential positive signal line CANH and the differential negative signal line CANL without any time difference. The electronic device 400 may be a high-speed device.

In the other implementations, the digital signal remapping circuit, the first driving circuit, and the second driving circuit may have the other modifications. Any technology that provides a CANTX remapping function inside an MCU, to provide two outputs for CAN driving falls within the scope of this case.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microcontroller unit, comprising:
a controller area network controller, generating a transmission signal in digital form for a controller area network;
a digital signal remapping circuit, remapping the transmission signal into a first chip output signal and a second chip output signal;
a first pin, configured to output the first chip output signal to drive a differential positive signal line of the controller area network; and
a second pin, configured to output the second chip output signal to drive a differential negative signal line of the controller area network.

2. The microcontroller unit as claimed in claim 1, further comprising:
a third pin, coupled to the differential positive signal line of the controller area network;
a fourth pin, coupled to the differential negative signal line of the controller area network; and
a comparator, receiving signals from the third pin and the fourth pin for comparison, to generate a received signal in digital form, which is coupled to the controller area network controller.

3. The microcontroller unit as claimed in claim 1, wherein the digital signal remapping circuit comprises:
a first multiplexer, outputting the first chip output signal as indicated by the transmission signal; and
a second multiplexer, outputting the second chip output signal as indicated by the transmission signal.

4. The microcontroller unit as claimed in claim 3, wherein the digital signal remapping circuit further comprises:
a third multiplexer, having a first input terminal that receives a high potential, a second input terminal that receives a low potential, and a third input terminal that is floating, and having an output terminal coupled to a first input terminal of the first multiplexer;
a fourth multiplexer, having a first input terminal that receives the high potential, a second input terminal that receives the low potential, a third input terminal that is floating, and having an output terminal coupled to a second input terminal of the first multiplexer;
a fifth multiplexer, having a first input terminal that receives the high potential, a second input terminal that receives the low potential, and a third input terminal that is floating, and having an output terminal coupled to a first input terminal of the second multiplexer; and
a sixth multiplexer, having a first input terminal that receives the high voltage potential, a second input terminal that receives the low voltage potential, and a third input terminal that is floating, and having an output terminal coupled to a second input terminal of the second multiplexer;
wherein:
the third multiplexer and the fourth multiplexer are controlled based on how the first chip output signal output from the first pin drives the differential positive signal line; and
the fifth multiplexer and the sixth multiplexer are controlled based on how the second chip output signal output from the second pin drives the differential negative terminal signal line.

5. The microcontroller unit as claimed in claim 3, wherein:
a first input terminal owned by the first multiplexer and corresponding to the 0 value of the transmitted signal receives a high potential;
a second input terminal owned by the first multiplexer and corresponding to the 1 value of the sent signal is floating;
a first input terminal owned by the second multiplexer and corresponding to the 0 value of the transmitted signal receives a low potential; and
a second input terminal owned by the second multiplexer and corresponding to the 1 value of the transmitted signal is floating.

6. An electronic device, comprising:
the microcontroller unit as claimed in claim 3, wherein a first input terminal owned by the first multiplexer and corresponding to the 0 value of the transmission signal receives a low potential, a second input terminal owned by the first multiplexer and corresponding to the 1 value of the transmission signal receives a high potential, a first input terminal owned by the second multiplexer and corresponding to the 0 value of the transmission signal receives the high potential, and a second input terminal owned by the second multiplexer and corresponding to the 1 value of the transmission signal receives the low potential;
a first driving circuit, coupled between the first pin and the differential positive signal line; and
a second driving circuit, coupled between the second pin and the differential negative terminal signal line.

7. The electronic device as claimed in claim 6, wherein the first driving circuit comprises:
a first transistor;
a first resistor; and
a second resistor;
wherein the first transistor has an emitter coupled to a voltage source, a base coupled to the first output pin through the first resistor, and a collector coupled to the differential positive signal line through the second resistor.

8. An electronic device, comprising:
the microcontroller unit as claimed in claim 3, wherein a first input terminal owned by the first multiplexer and corresponding to the 0 value of the transmission signal receives a low potential, a second input terminal owned by the first multiplexer and corresponding to the 1 value of the transmission signal receives a high potential, a first input terminal owned by the second multiplexer and corresponding to the 0 value of the transmission signal receives the low potential, and a second input terminal owned by the second multiplexer and corresponding to the 1 value of the transmission signal is floating; and
a first driving circuit, coupled between the first pin and the differential positive signal line;
wherein the second pin is directly connected to the differential negative signal line.
